(19) United States
(12) Patent Application Publication
(10) Pub. No.: US 2015/0192261 A1
(43) Pub. Date: Jul. 9, 2015

(54) Linear Lighting Apparatus

(71) Applicant: Richard L. May, Hardwick, MA (US)

(72) Inventor: Richard L. May, Hardwick, MA (US)

(21) Appl. No.: 14/588,240

(22) Filed: Dec. 31, 2014

Related U.S. Application Data
(60) Provisional application No. 61/925,088, filed on Jan. 8, 2014.

(51) Int. Cl. F21S 4/00; F21V 29/74; H05B 33/08; F21S 8/04

(52) U.S. Cl. CPC F21S 4/008; F21S 8/046; F21V 29/74; H05B 33/0854; F21Y 2103/003

(57) ABSTRACT

A die-cast linear lighting housing having a plurality of co-linear printed circuit boards (PCBs). Each of the PCBs includes a plurality of surface mounted LEDs having a common axis and each of the PCBs is non-coplanar with respect to each of the other PCBs, The die-cast linear lighting housing is die cast with integral thermal conductivity features for dissipating heat generated by the plurality of surface mounted LEDs.

### CROSS-REFERENCE TO RELATED APPLICATIONS

The present application is related to, claims the earliest available effective filing date(s) from (e.g., claims earliest available priority dates for other than provisional patent applications; claims benefits under 35 USC §1.19(e) for provisional patent applications), and incorporates by reference in its entirety all subject matter of the following listed application(s) (the “Related Applications”) to the extent such subject matter is not inconsistent herewith; the present application also claims the earliest available effective filing date(s) from, and also incorporates by reference in its entirety all subject matter of any and all parent, grandparent, great-grandparent, etc. applications of the Related Application(s) to the extent such subject matter is not inconsistent herewith:

1. U.S. provisional patent application 61/925088, entitled “A Linear Lighting Apparatus”, naming Richard L. May as inventor, filed 08 Jan. 2014.

### BACKGROUND

1. Field of Use

This invention concerns linear lighting apparatus to facilitate inspecting work-pieces and parts in a machine environment such as, for example, a lathe or, for another example, a computer numerical controlled (CNC) machine.

2. Description of Prior Art (Background)

Conventional illumination for CNC machines and the like often consisted of a fluorescent bulb along with ballast powered by a 110 volt AC power source. Such bulbs are not environmentally friendly because they contain mercury and the presence of such high voltage is a potential hazard to the worker. Most importantly, the fluorescent light in the viewing area is not as bright and uniform as might be desired to enable a worker to carefully examine a work-piece in the viewing field.

More recently, light sources have been developed which utilize light-emitting diodes as the light source. However, invariably such diodes are of the bottle type with an integral lens which focuses the light from the diode to a. point. Therefore, when pluralities of these diodes are arranged along an axis, the focused beams therefrom form a line of hot spots at a fixed distance below the lens. Thus the amount of light incident on a. machining work-piece changes non-uniformly when the part is manipulated in the light field

Other drawbacks of prior illumination devices are that they are not ergonomically friendly and are often not water proof and oil proof leading to failure when operated in the harsh oil and solvent environment of an operating lathe or CNC machine. In addition, prior art illumination devices for lathes, CNC machines, and the like, often required relatively high power and were often bolted or otherwise fastened to the machine. This lead to breeching machine integrity and also had the undesirable consequence that once the illuminating source location was fixed it was difficult to Change the location to illuminate different machine jobs.

Additional drawbacks of prior fluorescent illumination devices include the requirement of ballast to start the fluorescent lamp. A defective ballast could cause the lamp to explode or otherwise fail, thereby releasing mercury vapor from the lamp interior. In addition, other starting methods of a fluorescent lamp include constant preheating of the fluorescent light cathode with low AC power. It will be appreciated that this approach is not power consumption sensitive and constant power on could be dangerous in a situation such as an oil fire within the machine.

### BRIEF SUMMARY

The invention accordingly comprises the features of construction, combination of elements and arrangements of parts which will be exemplified in the construction hereinafter set forth, and the scope of the invention will be indicated in the claims.

The invention is also directed towards a single piece die-cast housing apparatus for structurally angling rows of light emitting diodes to provide uniform illumination while simultaneously dissipating heat generated by the light emitting diodes.

A die-cast linear lighting housing is also provided. The housing includes a center printed circuit board (PCB) mounting stanchions for supporting, a first light emitting diode (LED) circuit board: a left PCB mounting stanchions for supporting a second light emitting diode (LED) circuit board, wherein the left PCB mounting stanchions comprises a PCB slope angle of substantially IS degrees towards the center PCB mounting stanchion, a right PCB mounting stanchions for supporting a third light emitting diode (LED) circuit board, wherein the right PCB mounting stanchions comprises a PCB slope angle of substantially 15 degrees towards the center PCB support. in addition to providing angular support, the left, right, and center stanchions provide a heat dissipation path for conducting heat generated by the LED circuit boards to a plurality of radiator fins. Additionally, the left, right, and center mounting stanchions provide, a heat dissipation path for conducting heat generated by the LED circuit boards to housing mounting stanchions.

In accordance with another embodiment the invention is also directed towards a die-cast linear lighting system. The die-cast linear lighting system includes a die-cast housing having, a plurality of center mounting stanchions for supporting a light emitting diode (LED) printed circuit hoard (PCB). The plurality of center mounting stanchions is disposed along a common linear axis. A second plurality of mounting stanchions for supporting a second LED PCB, are disposed to the left of the plurality of center mounting stanchions, and form a second common linear axis having a predetermined slope angle with respect to the first common linear axis. The system also includes a third plurality of mounting stanchions for supporting a third LED PCB, wherein the third plurality of mounting stanchions are disposed to the right of the plurality of center mounting stanchions, and are disposed to form a third common linear axis, wherein the third common linear axis comprises a second predetermined slope angle with respect to the first common linear axis (i.e., the third common linear axis is not coplanar with the first common linear axis).

### BRIEF DESCRIPTION OF THE DRAWINGS

For a fuller understanding of the nature and objects of the invention, reference should be made to the following detailed description taken in connection with the accompanying drawings, in which:

FIG. 1 is a perspective view of a typical machine using a linear lighting apparatus incorporating the invention;

FIG. 2 is a top perspective view of the linear lighting apparatus shown in FIG. 1;

FIG. 3 is a bottom perspective view of the linear lighting apparatus shown in FIG. 2.

FIG. 4 is a top view of the linear lighting apparatus shown in FIG. 2;

FIG. 5 is a bottom view of the linear lighting apparatus shown in FIG. 2;

FIG. 6 is a side view of the linear lighting apparatus shown in FIG. 2;

FIG. 7 is an end view of the linear lighting. apparatus shown in FIG. 2;

FIG. 8 is another end view of the linear lighting apparatus shown in FIG. 2;

FIG. 9 is a block diagram of one example of the FIG. 2 electrical system;

FIGS. 10A and 10B are exemplary illustrations of the light field produced by the linear apparatus shown in FIG. 2 for 18 inch and 36 inch distances, respectively;

FIGS. 11A and 11B are exemplary illustrations of the left or right tilt features of the linear light apparatus shown in FIG. 2, respectively;

FIG. 12A is an illustration of the area of maximum illumination of the linear lighting, apparatus shown in FIG. 2; and

FIG. 12B is a cut-away view of one end of the linear lighting apparatus shown in FIG. 2.

### DETAILED DESCRIPTION

The following brief definition of terms shall apply throughout the application:

The term “outer” or “outside” refers to a direction away from a user, while the term “inner” or “inside” refers to a direction towards a user;

The term “comprising” means including but not limited, to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present mention (importantly, such phrases do not necessarily refer to the same embodiment);

If the specification describes something as “exemplary” or an “example,” it should be understood that refers to a non-exclusive example; and

If the specification states a component or feature “may,” “can,” “could,” “should,” “preferably,” “possibly,” “typically,” “optionally,” “for example,” or “might” (or other such language) be included or have a characteristic, that particular component or feature is not required to be included or to have the characteristic,

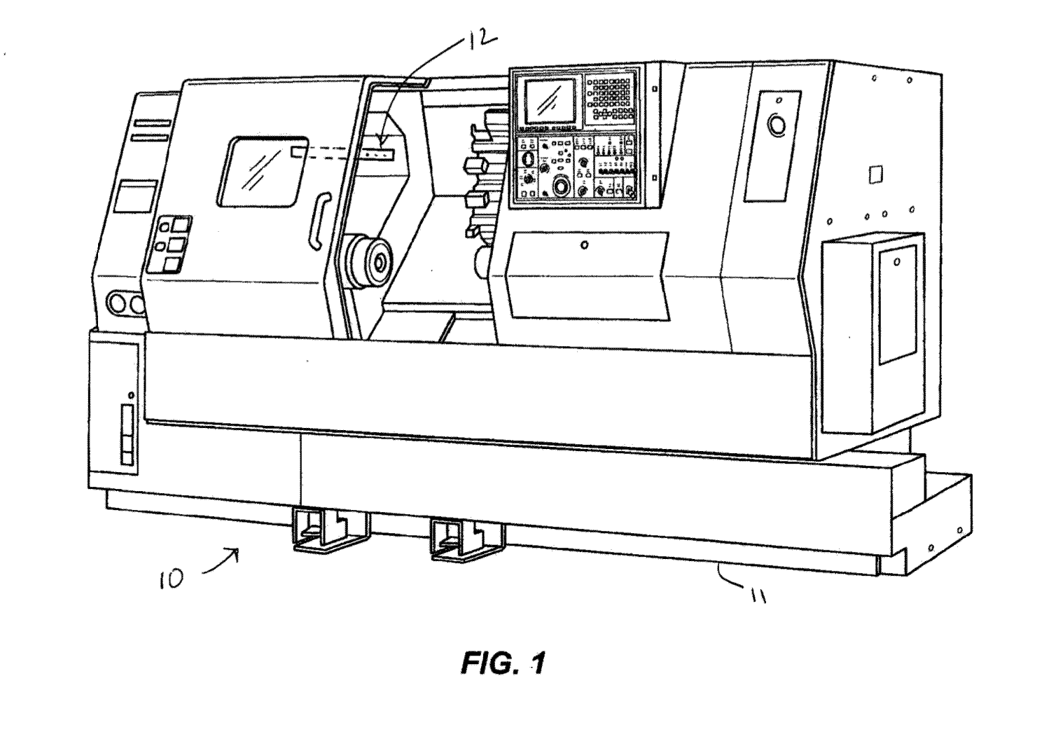

Referring to FIG. 1 there is shown a perspective view of a typical machine 11 using a linear lighting apparatus 12 incorporating the invention. It will he appreciated that the typical machine 11 may be any suitable machine such as, but not limited to, a CNC machine, as lathe, or any machine or environment requiring suitable lighting.

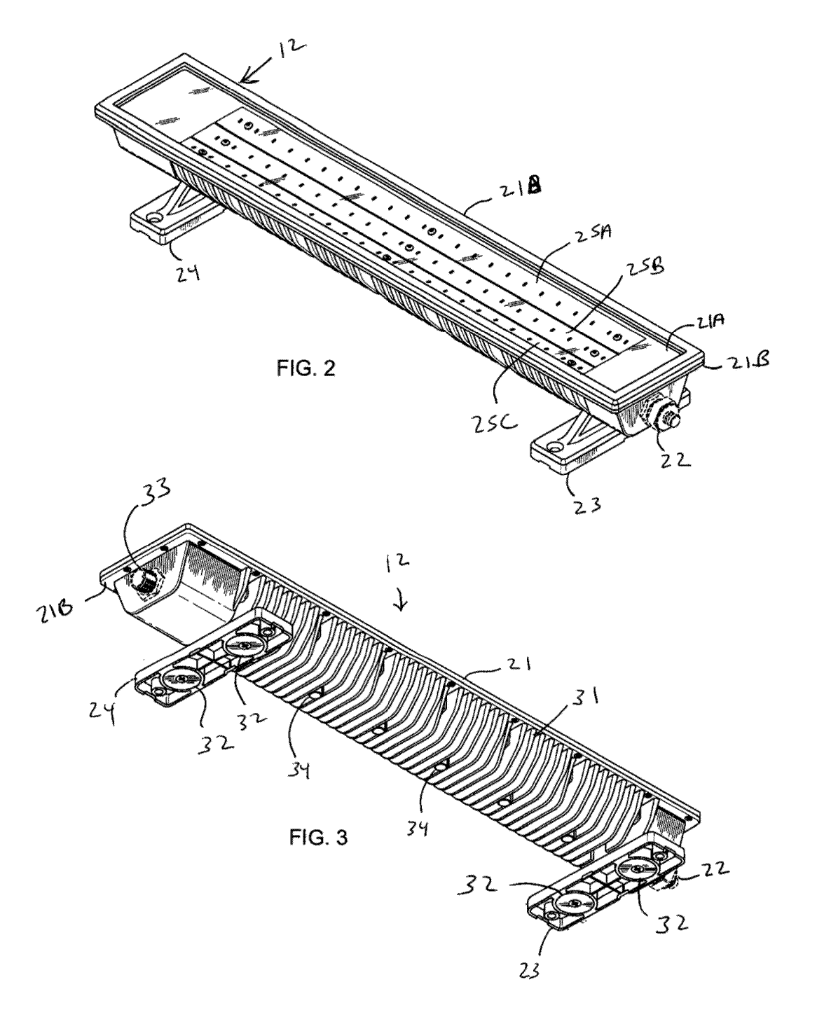

Referring also to FIG. 2 there is shown a top perspective view of the linear lighting apparatus 12 shown in FIG. 1. Linear lighting apparatus 12 includes, tempered safety glass 21A, die-cast body 21B, light emitting diode (LED) circuit boards 25A, 258 and 25C, connector option 22 and housing mounting stanchions 23, 24, It will be understood that any suitable manufacturing method may be used.

Still referring to FIG. 2, die cast body 21B may be cast of a suitable lightweight metal such as, for example, aluminum, or aluminum alloy. It will be appreciated that a suitable die cast metal will exhibit desirable weight characteristics, such as light weight, and other desirable characteristics such as high thermal conductivity. Likewise, housing mounting stanchions 23, 24, will also consist of a suitable high thermal conductivity. It will be appreciated that housing mounting stanchions 23,24 may be demountably affixed to die cast body 21B to facilitate thermal transfer from die cast body to mounting stanchions 23, 24. It will also be understood that mounting stanchions 23, 24 include a rotatable pivot point for rotating die cast body 21. The degree of rotation may be any suitable degree of rotation such as a 45 degree rotation.

LED circuit boards 25A, 25B, 25C may be suitable LED circuit boards for mounting a plurality of LEDs on each circuit board as described herein. It will be appreciated that. LED circuit boards 25A, 25C are tilted inwards with respect to LED circuit board 25B (i.e., circuit boards 25A and 25C each lie in a plane with a predetermined tilt with respect to the plane of circuit board 25B). It will be appreciated that the distribution of the LEDs 41 on circuit boards 25A, 25B, and 25C and in conjunction with the tilted LED circuit boards 25A, 25B provide an optimum light field as discussed herein. The degree of LED circuit boards 25A, 25C tilt may be any suitable tilt degree. Furthermore, in certain embodiments each of time LED board tilt angles may be independent of each of the other LED board tilt angles. In one embodiment the inward tilt angles for LED circuit boards 25A, 25B may be substantially 15 degrees off the horizontal. As will be described later LED circuit boards may be mounted to mounting surfaces formed as part of die cast body 21B. The mounting surfaces are die cast to form PCB structural support and thermal conduction points aligned with LEDs 41 on LED circuit boards 25A. 25B, 25C.

Referring also to FIG. 3 there is shown a bottom perspective view of the linear lighting apparatus 12 shown in FIG. 2. Linear lighting apparatus 12 includes mounting stanchions 23, 24 demountably attached to die cast body 21B. Mounting stanchions 23, 24 each include at least one mounting magnet 32. The mounting magnet 32 may be any suitable magnet such as neodymium. Linear lighting, apparatus 12 also includes input power plug 22 and daisy chain connector 22. The die cast body includes rigid supports 34 and thermal radiator fins 31.

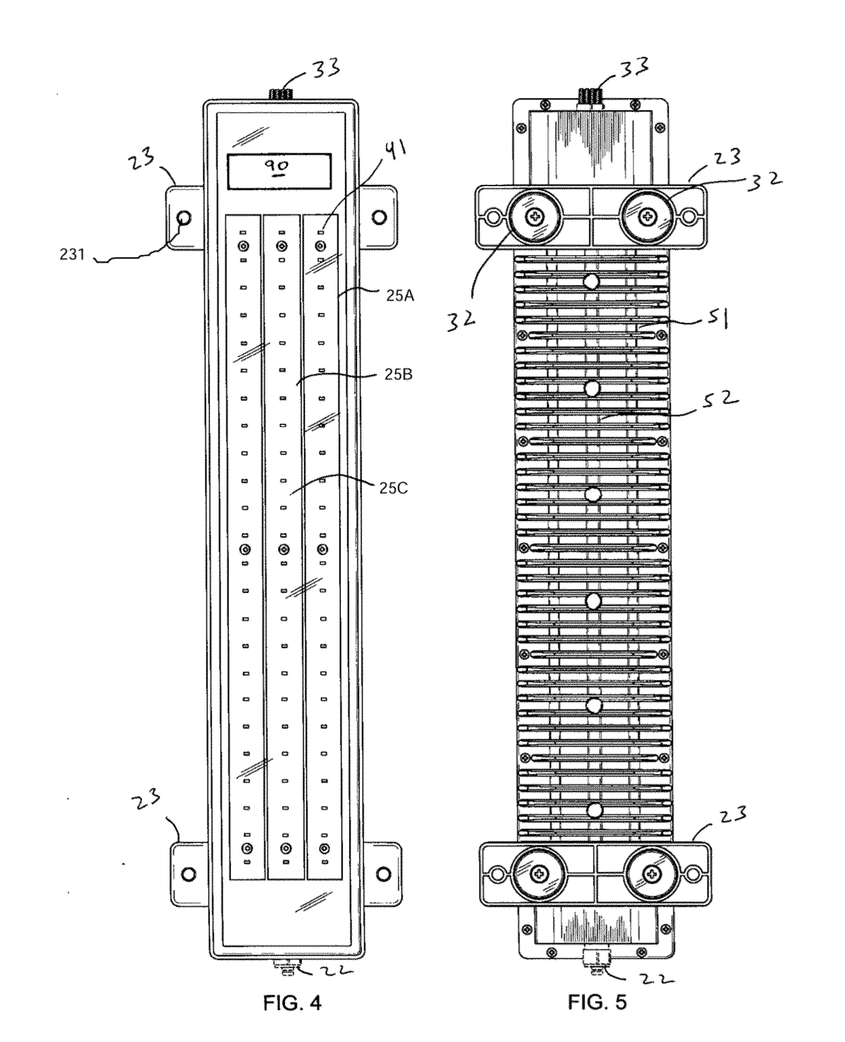

Referring also to FIG. 4 there is shown a top view of the linear lighting apparatus 12 shown in FIG. 2. Linear lighting apparatus 12 includes control circuitry 90, described herein. Linear lighting apparatus 12 also includes LED circuit boards 25A, 258, 25C, each of which includes a plurality of surface mount LEDs 41. LEDs 41 may be any suitable LED such as, for example, an LED having characteristics such as chromaticity coordinates (x, y) ranging from 0.3 to 0.41 and 0.29 to 0.41, respectively; typical forward voltages ranging from 2.9 (V) to 6.4 (V): I_{F}20 to 150 (mA) and directivity 20½ substantially 120 (degrees).

Also visible in FIG. 4 is countersunk holes 231 (two per mounting stanchion) for permanent installation.

Referring also to FIG. 5 there is shown a bottom view of the linear lighting apparatus 12 shown in FIG. 2. Linear lighting apparatus 12 includes die cast body 21B which further includes a substantially rectangular solid die cast stabilizer 51. Die cast stabilizer 51 provides a stabilizing, weight and a thermal heat sink disposed between the LED circuit boards 25A, 25B, 25C and thermal radiator fins 52 (See also FIG. 3-item 31). The bulk of die cast stabilizer 51 provides passive thermal management and thermal conductivity between the LED circuit boards 25A, 25B, 25C mounting surfaces and radiator fins 52. In addition stabilizer 51 also provides thermal conductivity to mounting stanchions 23, 24. Also shown in FIG. 5 are neodymium magnets 32.

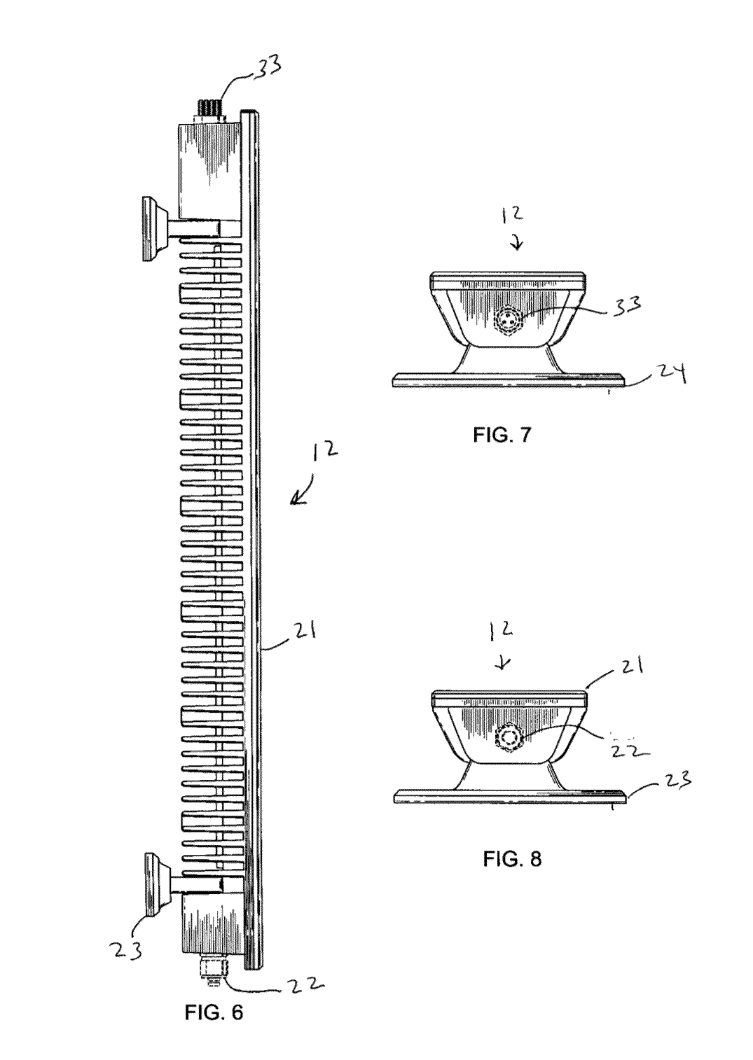

Referring also to FIGS. 6-8 there is shown a side view and end views of the linear lighting apparatus 12 shown in FIG. 2. As shown, linear lighting apparatus 12 includes power connector 33 and daisy chain connector 22. Power connector 33 may be any suitable power connector for connecting DC voltage such as DC voltage provided by an AC adapter providing 24V DC. Daisy chain connector 22 provides output power 24VDC for inputting to another linear lighting apparatus 12. Both power connector 22 and daisy chain connector 22 may be liquid and solvent resistant to prevent structural breakdown. In addition, power connector 22 and daisy chain connector 22 are attached to body 21 to form a watertight seal.

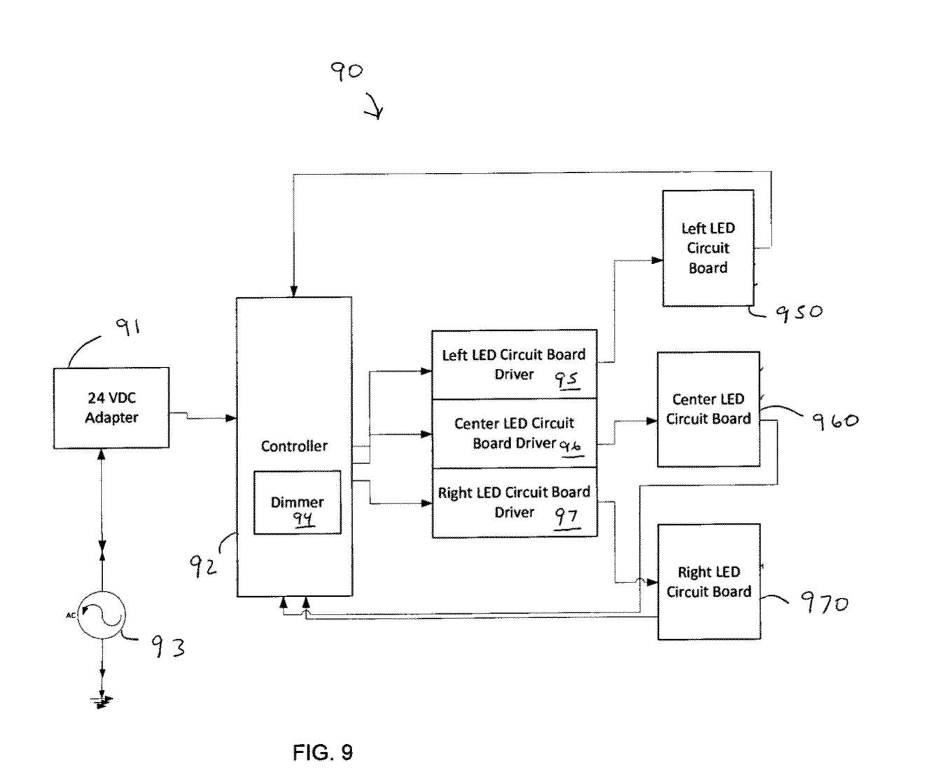

Referring to FIG. 9 there is shown a block diagram of one example of control system 90. As shown in FIG. 9, the PCBs, 950, 960, 970 have separate drivers 95, 96, and 97, respectively and the current to the drivers is controlled by a controller 92 which receives DC power from power adaptor 91. The dimmer 94 may be a manual dimmer or a thermally sensitive dimmer adapted to sense each the operating or environmental (ambient) temperature of each LEI) 41 per PCB board and adjust the current to the LED if the thermal measurement exceeds a predetermined threshold. The dimmer 94 may also be adapted to measure the aggregate operating or environmental temperature per PCB and adjust the current to the PCB board accordingly. In manual mode the dimmer may dim the LEDs from 100-5%, or turn off PCB LEDs 41 as desired for contrasting control. It will be understood that while only one dimmer is shown there may be multiple dimmers, e.g., a manual dimmer and a thermally sensitive dimmer. Similarly, dimmer 94 may incorporate both manual operating features and thermal sensitivity features,

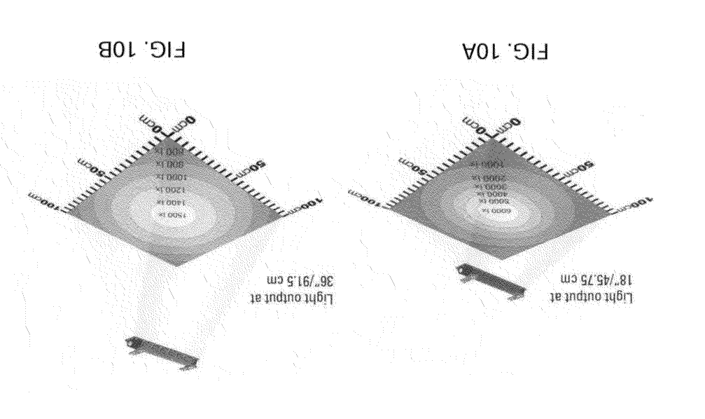

FIGS. 10A and 10B are exemplary illustrations of the light field produced by the linear apparatus shown in FIG. 2 for 18 inch and 36 inch distances, respectively.

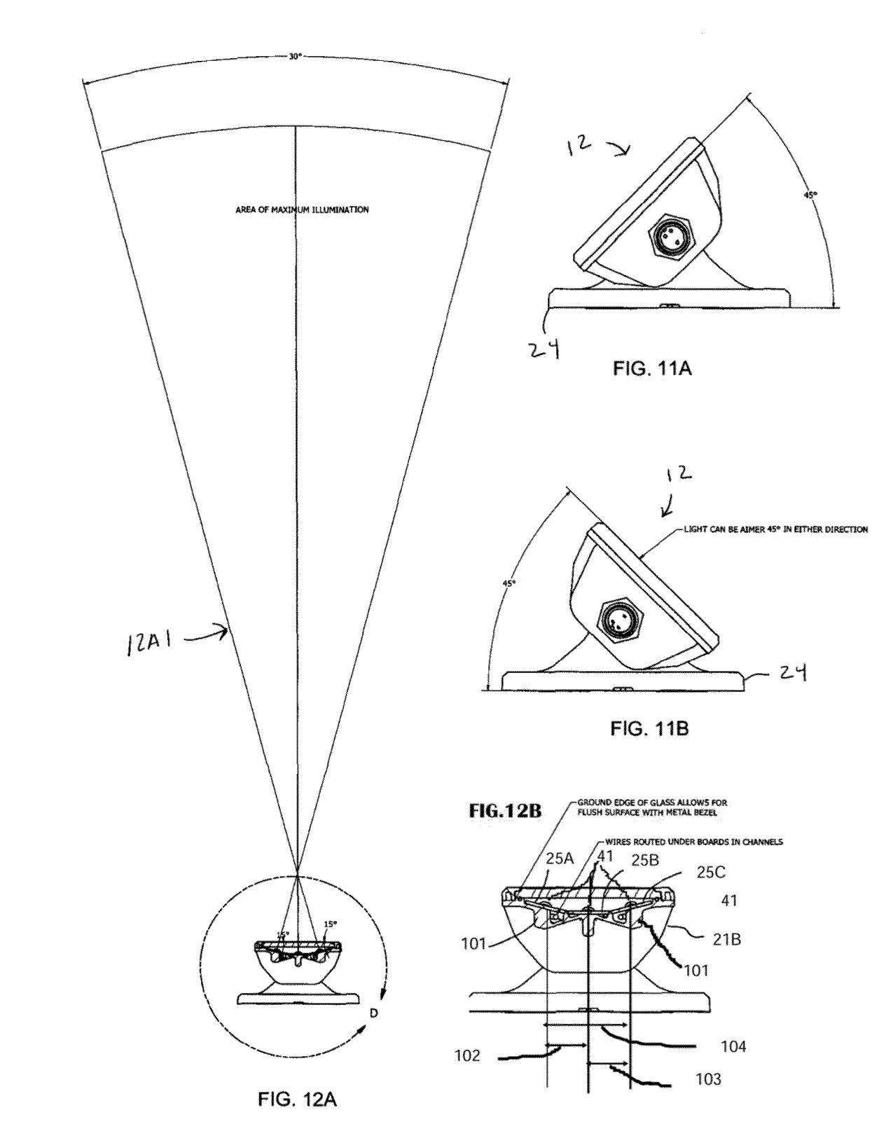

Referring also to FIGS 11A and 11B there are shown exemplary illustrations of the left or right tilt features of the linear light apparatus shown in FIG. 2, respectively. The pivot points are via mounting stanchions 23, 24. It will be appreciated and understood that mounting stanchions 23, 24, maintain full thermal contact with body 21B in any pivot position.

Turning also to FIG. 12A there is shown an illustration of the area 12A1 of maximum illumination of the linear lighting apparatus shown in FIG. 2. It will be understood that the area 12A1 is dependent upon the angular orientation of PCB LED circuit boards 25A, 25B, and 25C and the intra distance between the boards as shown in FIG. 12B, items 102, 103, 104. Also shown in FIG. 12 is glass surface 21A mating flush with a metal bezel attached to body 21B.

It will thus be seen that the objects set forth above, among those made apparent from the preceding description, are efficiently attained and since certain changes may be made in the above constructions without departing from the scope of the invention, it is intended that all matter contained in the above description or shown in the accompanying drawings shall be interpreted as illustrative and not in a limiting sense.

It is also to be understood that the following claims are intended to cover all of the generic and specific features of the invention described herein.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, scope of the claims shall be considered on their own merits in light of this disclosure, but should not be constrained by the headings set forth herein.

Finally, it will be understood that use of broader terms such as comprises, includes, and having should be understood to provide support for narrower terms such as consisting of, consisting essentially of, and comprised substantially of. Use of the term “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

What is claimed is:

1. A linear lighting housing comprising:
a first plurality of center mounting stanchions for supporting a first light emitting diode (LED) printed circuit board (PCB);
a second plurality of mounting stanchions for supporting a second LED PCB, wherein the second plurality of mounting stanchions are disposed to the left of the plurality of center mounting stanchions and wherein the second plurality of mounting stanchions comprise a slope angle of substantially 15 degrees towards the first plurality of center mounting stanchions; and
a third plurality of mounting stanchions for supporting a third LED PCB, wherein the third plurality of mounting stanchions are disposed to the right of the plurality of center mounting stanchions and wherein the third plurality of mounting stanchions comprise a slope angle of substantially 15 degrees towards the first plurality of center mounting stanchions.

2. The linear lighting housing as in claim 1 further comprising:
the first plurality of center mounting stanchions comprising:
a first common linear axis;
the second plurality of mounting stanchions comprising:
a second common linear axis;
the third plurality of mounting stanchions comprising:
a third common linear axis; and
wherein the first, second and third common linear axes are co-parallel.

3. The linear lighting housing as in claim 1 further comprising a plurality of integrated radiator fins.

4. The linear lighting housing as in claim 3 further comprising a thermal conduction path from the first, second, and third plurality of mounting stanchions to the plurality of radiator fins.

5. The linear lighting housing as in. claim 1 further comprising a plurality of demountable housing mounting stanchions, wherein each of the demountable housing mounting stanchions is rotatable with respect to the die-cast linear lighting housing, and wherein each of the plurality of housing mounting stanchions each comprise at least one magnet.

6. The linear lighting apparatus as in claim 1 further comprising a daisy chain connector.

7. The linear lighting housing as in claim 1 further comprising a plurality of demountable LED PCBs wherein each of the demountable LED PCBs comprise a plurality of LEDs, and wherein each of the plurality of LEDs on each of the plurality of PCBs are disposed linearly on the PCB.

8. The linear lighting housing as in claim 7 wherein each of the first, second, and third plurality of mounting stanchions form PCB structural support and thermal conduction points aligned with, one-to-one, each of the plurality of LEDs.

9. The linear lighting housing as in claim 7 further comprising:
a LED PCB controller, wherein the LED PCB controller comprises:
a dimmer; and
a plurality of LED PCB drivers for providing driver current to the plurality of demountable LED PCBs, and wherein the plurality of LED PCB drivers are connectable to the dimmer.

10. The linear lighting housing as in claim 9 wherein the dimmer comprises a manual dimmer, wherein the manual dimmer operates to dim the plurality of LEDs from approximately 100% to 5% to off.

11. The linear lighting housing as in claim 9 wherein the dimmer comprises a thermally sensitive dimmer adapted to sense the environmental temperature of each of the LEDs of each of the plurality of LEDs and adjust the driver current to the plurality of demountable LED PCBs if the thermal measurement exceeds a predetermined threshold.

12. The linear lighting housing as in claim 9 wherein the dimmer comprises:
a thermally sensitive dimmer mode adapted to sense the environmental temperature of each of the LEDs of each of the plurality of LEDs and adjust the driver current to the plurality of demountable LED PCBs if the thermal measurement exceeds a predetermined threshold; and
a manual dimmer mode, wherein the manual dimmer operates to dim the plurality of LEDs from approximately 100% to 5% to off.

13. A linear lighting system comprising:
a die-cast housing, wherein the die-cast housing comprises:
a first plurality of center mounting stanchions for supporting a first light emitting diode (LED) printed circuit board (PCB), wherein the first plurality of center mounting stanchions are disposed to form a first common linear axis;
a second plurality of mounting stanchions for supporting a second LED PCB, wherein the second plurality of mounting, stanchions are disposed to the left of the plurality of center mounting stanchions, and wherein the second plurality of center mounting stanchions are disposed to form a second common linear axis, wherein the second common linear axis comprises a predetermined slope angle with respect to the first common linear axis; and
a third plurality of mounting stanchions for supporting a third LED PCB, wherein the third plurality of mounting stanchions are disposed to the right of the plurality of center mounting stanchions, and wherein the third plurality of center mounting stanchions are disposed to form a third common linear axis, wherein the third common linear axis comprises a predetermined slope angle with respect to the first common linear axis.

14. The linear lighting system as in claim 13 further comprising:
a thermal stabilizer;
a plurality of integrated radiator fins; and
wherein the thermal stabilizer is disposed between the plurality of integrated radiator fins and the first, second and third plurality of mounting stanchions.

15. The housing as in claim 14 further comprising a plurality of demountable housing, mounting stanchions, wherein each of the demountable housing mounting stanchions is rotatable with respect to the die-cast housing, and wherein each of the plurality of housing mounting stanchions each comprise at least one magnet, and wherein each of the plurality of the demountable housing mounting stanchions comprise a thermal conduction path.

16. The linear lighting system as in claim 13 further comprising a plurality of demountable LED PCBs, wherein each of the demountable LED PCBs comprise at least one plurality of LEDs disposed along a common axis, and wherein each of the at least one plurality of LEDs disposed along a common axis correspond with at least one of the first, second, third common axis.

17. The linear lighting system as in claim 16 wherein each of the first, second, and third plurality of mounting stanchions form PCB structural support and thermal conduction points aligned with, one-to-one, at least one of the plurality of LEDs disposed along a common axis.

18. The linear lighting system as in claim 16 further comprising:
a plurality of LED PCB drivers for providing driver current to the plurality of demountable LED PCBs;
a LED PCB controller, wherein the LED PCB controller comprises:
a dimmer, wherein the dimmer comprises:
a thermally sensitive dimmer mode adapted to thermally measure the ambient and operation temperature of each of the LEDs of each of the plurality of LEDs and adjust driver current to the plurality of demountable LED PCBs if the thermal measurement exceeds a predetermined threshold; and
a manual dimmer mode, wherein the manual dimmer operates to dim the plurality of LEDs from approximately 100% to 5% to off.

19. A thermally stabilized light emitting diode (LED) housing comprising:
at least one plurality of thermally conductive mounting stanchions having first mounting surfaces disposed along a common axis;
at least one second plurality of thermally conductive mounting stanchions having second mounting surfaces disposed along a second common axis, wherein the second mounting surfaces are not coplanar with the first mounting surfaces;
a plurality of thermal radiator fins; and
a thermal heat sink stabilizer disposed between the at least one plurality of thermally conductive mounting stanchions and the plurality of thermal radiator fins.

20. The thermally stabilized light emitting diode (LED) housing as in claim 19 further comprising a plurality of demountable housing mounting stanchions, wherein each of the demountable housing mounting stanchions is rotatable with respect to the die-cast thermally stabilized light emitting diode (LED) housing, and wherein each of the plurality of housing mounting stanchions provide a thermal conduction path to/from the thermal heat sink stabilizer.
